(19) United States
(12) Patent Application Publication
(10) Pub. No.: US 2008/0297363 A1
(43) Pub. Date: Dec. 4, 2008

(54) DOMESTIC ELECTRIC APPLIANCE NOTIFICATION SYSTEM, PORTABLE TERMINAL APPARATUS, DOMESTIC ELECTRIC APPLIANCE, AND OPERATION COMPLETION NOTIFYING METHOD

(76) Inventor: Yasushi Fukushige, Kanagawa (JP)

Correspondence Address: MCDERMOTT WILL & EMERY LLP, 600 13TH STREET, NW, WASHINGTON, DC, 20005-3096, US

(21) Appl. No.: 12/124,784

(22) Filed: May 21, 2008

(30) Foreign Application Priority Data
May 30, 2007 (JP) P. 2007-143581

(51) Int. Cl. G08B 21/00

(52) U.S. Cl. 340/635

(57) ABSTRACT

In a domestic electric appliance notification system containing a domestic electric appliance and a portable terminal apparatus 1000 capable of being communicated with the domestic electric appliance in a wireless manner, the below-mentioned domestic electric appliance notification system is provided: That is, in the notification system, the domestic electric appliance transmits both appliance sort information for specifying an appliance to which an alarm is notified, and operation completion information corresponding to the appliance sort information in a wireless manner; and the portable terminal apparatus 1000 receives the operation completion information transmitted from the domestic electric appliance, and sets an alarm time based upon the operation completion information, and then, notifies an alarm based upon the set alarm time by emitting light, by performing a vibrating operation, or by producing a sound.

### BACKGROUND OF THE INVENTION

1. Field of the Invention

The present invention generally relates to a domestic electric appliance notification system, a portable terminal apparatus, a domestic electric appliance, and an operation completion notifying method. More specifically, the present invention is directed to the domestic electric appliance capable of transmitting operation completion information in a wireless manner, and also, directed to the portable terminal apparatus capable of notifying an alarm by light, a sound, or a vibration, and further capable of setting an alarm time via a wireless function from an external unit.

2. Description of the Related Art

Referring now to FIG. 8, a description is made of a system for notifying a completion of operation in a conventional domestic electric appliance.

FIG. 8 indicates a structure of the conventional domestic electric appliance. In this drawing, reference numeral 2000 shows the conventional domestic electric appliance; reference numeral 2011 indicates a light emitting apparatus for notifying an operation completion of the domestic electric appliance; reference numeral 2012 represents a sound producing apparatus for notifying an operation completion of the domestic electric appliance; and reference numeral 2031 indicates a control apparatus which calculates an operation completion time of the domestic electric appliance, and further, notifies such signals for operating the light emitting apparatus 2011 and the sound producing apparatus 2012 when the operation of the domestic electric appliance is completed. Also, reference numeral 2041 shows a timer for counting an operation time, and for notifying expiration of the operation time to the control apparatus 2031; reference numeral 2051 shows an input apparatus with respect to the conventional domestic electric appliance; reference numeral 2131 represents a timer setting signal; reference numeral 2111 indicates an appliance operating signal, reference numeral 2141 shows a timer counting expiration signal; and also, reference numeral 2151 denotes an input signal.

When an operation of the conventional domestic electric appliance 2000 is commenced by entering an input instruction from the input apparatus 2051, an operation starting signal is notified from the input apparatus 2051 to the control apparatus 2031, the control apparatus 2031 calculates an operation completion time and performs a timer setting operation with respect to the timer 2041. When the setting time of the timer 2041 is expirated, the expiration of the timer setting time is notified from the timer 2041 to the control apparatus 2031. The control apparatus 2031 notifies an appliance operating signal 2111 with respect to the light emitting apparatus 2011 and the sound producing apparatus 2012 so as to emit light and produce sounds respectively, so that the control apparatus 2031 notifies to a user such a fact that the operation is completed.

Very recently, there are other domestic electric appliance notification systems in which while the domestic electric appliance 2000 is connected to controllers installed in kitchens and the like, the controllers and monitors of respective domestic electric appliances connected to the controllers are used by users in order to grasp statuses of the domestic electric appliances (refer to, for instance, patent publications 1 and 2).

Patent Publication 1: JP-A-2005-342079 (page 13, FIG. 3)

Patent Publication 2: JP-A-2004-286612 (claim 8, FIG. 1)

However, in the above-described domestic electric appliance notification system, when users are located under such an environment that the users cannot hear sounds, the users cannot grasp the notification of the operation completion as to the domestic electric appliances. Also, in the case that the confirmations are made by employing the monitors, or by checking the light emissions, the users must continuously and visually recognize the domestic electric appliances, or the users must move to such places where the domestic electric appliances can be visually recognized.

For instance, when a user depresses a washing start button in an automatic washing machine, the automatic washing machine calculates a time required until the washing operation is accomplished based upon weight of washing clothes. However, in order that the user can grasp the washing completion time, the user is required to wait until the washing completion time is displayed on a monitor of a main body of the automatic washing machine. Also, in such a case that a user operates a vacuum cleaner in a room which is separately located from a washing machine, there are some environments that the user cannot hear a completion sound of a washing operation produced from a main body of the washing machine, but also the user cannot grasp the completion of the washing operation notified by light emitted from the main body of the washing machine.

### SUMMARY OF THE INVENTION

The present invention has been made to solve the above-described conventional problems, and therefore, has an object to provide a domestic electric appliance notification system, a portable terminal apparatus, a domestic electric appliance, and an operation completion notifying method, capable of grasping an operation completion of the domestic electric apparatus in such a manner that operation completion information is notified to the portable terminal apparatus capable of performing a wireless communication with the domestic electric appliance, and an operation completion time is set as an alarm with respect to an alarm function capable of notifying the operation completion information by light, a sound, and a vibration, while the portable terminal apparatus is equipped with the alarm function.

A domestic electric appliance related to the present invention, is provided with wireless communication means and means for notifying operation completion information via a wireless communication apparatus. On the other hand, a portable terminal apparatus related to the present invention, is equipped with: alarm means; means for notifying an alarm by emitting light, by producing a sound, and/or by generating a vibration; wireless communication means for communicating with the domestic electric appliance in a wireless manner; and means for calculating an operation completion time instant from the received operation completion information so as to set the calculated operation completion time instant to the alarm means.

In accordance with the above-described domestic electric apparatus and the portable terminal apparatus, even under such an environment that a user cannot hear any sound, since the alarm is notified from the portable terminal apparatus, the user can grasp the operation completion of the domestic electric appliance. Also, the user is no longer required to continuously confirm the monitor fixed on the domestic electric appliance and the light emission.

Also, an operation completion notifying method, according to an aspect of the present invention, is featured by such an operation completion notifying method in which completion of an operation of a domestic electric appliance is notified by a portable terminal apparatus, comprising: a step in which the domestic electric appliance transmits appliance sort information and operation completion information corresponding to the appliance sort information in a wireless manner; a step in which the portable terminal apparatus receives the operation completion information transmitted from the domestic electric appliance and sets an alarm time based upon the received operation completion information; and a step in which the portable terminal apparatus notifies an alarm based upon the set alarm time by emitting light, by performing a vibrating operation, or by producing a sound. In this method, the appliance sort information implies such an information for specifying the sort of the domestic electric appliance.

In accordance with the above-described operation completion notifying method, the operation completion information is notified to the portable terminal apparatus capable of being communicated with the domestic electric appliance in the wireless manner, and the portable terminal apparatus sets the alarm time to the alarm function provided in the portable terminal apparatus, so that the user can grasp the completion of the operation of the domestic electric appliance.

Also, a domestic electric appliance notification system, according to another aspect of the present invention, is featured by such a domestic electric appliance notification system including a domestic electric appliance and a portable terminal apparatus capable of being communicated with the domestic electric appliance in a wireless manner, in which the domestic electric appliance transmits appliance sort information and operation completion information corresponding to the appliance sort information in the wireless manner; and the portable terminal apparatus receives the operation completion information transmitted from the domestic electric appliance and sets an alarm time based upon the received operation completion information so as to notify an alarm based upon the set alarm time by emitting light, by performing a vibrating operation, or by producing a sound.

In accordance with the above-described domestic electric appliance notification system, even under such an environment that the user cannot hear any sound, since the portable terminal apparatus notifies the alarm, the user can grasp the completion as to the operation of the domestic electric appliance, and further, the user is no longer required to continuously confirm the monitor fixed on the domestic electric appliance and also the light emitted therefrom.

Also, a portable terminal apparatus, according to another aspect of the present invention, is featured by such a portable terminal apparatus capable of being communicated with a domestic electric appliance in a wireless manner, comprising: a wireless apparatus for receiving operation completion information transmitted from the domestic electric appliance; an alarm time instant calculating apparatus for calculating an alarm time instant based upon the received operation completion information; and an alarm control apparatus for controlling a generation of an alarm based upon the calculated alarm time instant.

In accordance with the above-described portable terminal apparatus, since the alarm time instant is calculated based upon the operation completion information, even in such a case that the user is present at a room located apart from the domestic electric appliance under operation, the user can grasp the completion as to the operation of the domestic electric appliance.

Also, in the portable terminal apparatus of the present invention, the alarm time instant calculating apparatus is comprised of a timer for counting an operation time.

In accordance with the above-described portable terminal apparatus, since the timer for counting the operation time is provided, the alarm time instant can be calculated based upon the operation completion information.

Also, in the portable terminal apparatus of the present invention, the portable terminal apparatus is further comprised of a light emitting apparatus, a vibrating apparatus, or a sound producing apparatus, which produces an alarm by emitting light, by performing a vibrating operation, or by producing a sound in response to the control of the alarm control apparatus.

In accordance with the above-described portable terminal apparatus, even in such a case that the user is present at a room located apart from the domestic electric appliance under operation, the user can grasp the alarm by emitting the light, by performing the vibration operation, or by producing the sound from the portable terminal apparatus.

Also, in the portable terminal apparatus of the present invention, the wireless apparatus receives appliance identification information for specifying the domestic electric appliance.

In accordance with the above-described portable terminal apparatus, even in such a case that plural sets of domestic electric appliances are employed, the user can readily discriminate such a domestic electric appliance whose operation has been completed from other domestic electric appliances.

Also, in the portable terminal apparatus of the present invention, the wireless apparatus receives information which contains an operation completion time instant corresponding to the received appliance identification information.

In accordance with the above-described portable terminal apparatus, since the information which contains the operation completion time instant corresponding to the appliance identification information is received, even when the user is present at such a room located apart from the domestic electric appliance under operation, the user can grasp the operation completion time instant.

Also, in the portable terminal apparatus of the present invention, the portable terminal apparatus is further comprised of a storage apparatus which stores thereinto a light emitting pattern of the light emitting apparatus, a sound producing pattern of the sound producing apparatus, and a vibration pattern of the vibrating apparatus; in which the alarm control apparatus controls switching operations as to the light emitting pattern, the sound producing pattern, and the vibration pattern based upon the appliance identification information.

In accordance with the above-described portable terminal apparatus, since the light emitting pattern, the sound producing pattern, and the vibration pattern are switched based upon the appliance identification information, the user can readily identify such a domestic electric appliance to which the alarm is notified.

Also, in the portable terminal apparatus of the present invention, the storage apparatus is comprised of a data table which stores thereinto the appliance sort information and the operation completion time instant.

In accordance with the above-described portable terminal apparatus, since the data table for storing thereinto both the appliance sort information and the operation completion time instant information is employed, the portable terminal apparatus can readily perform the notification process operations of the operation completion with respect to the plural domestic electric appliances.

Also, in the portable terminal apparatus of the present invention, a frequency control apparatus for controlling a frequency characteristic of a sound produced from the sound producing apparatus is further employed.

In accordance with the above-described portable terminal apparatus, since the frequency characteristic of the sound produced by the sound producing apparatus is controlled, the portable terminal apparatus can readily identify the domestic electric appliance.

Also, a domestic electric appliance, according to a further aspect of the present invention, is featured by such a domestic electric appliance capable of being communicated with a portable terminal apparatus in a wireless manner, comprising: a timer for counting an operation time so as to produce a timer counting expiration signal; and a wireless apparatus for transmitting operation commencement information and operation completion information to the portable terminal apparatus in a wireless manner based upon the produced timer counting expiration signal.

In accordance with the above-described domestic electric apparatus, even under such an environment that the user cannot hear any sound, since the alarm is notified from the portable terminal apparatus, the user can grasp the operation completion of the domestic electric appliance. Also, the user is no longer required to continuously confirm the monitor fixed on the domestic electric appliance and the light emission.

Also, in the domestic electric appliance of the present invention, the wireless apparatus transmits appliance identification information.

In accordance with the above-described domestic electric appliance, even in such a case that plural sets of domestic electric appliances are employed, the user can readily discriminate such a domestic electric appliance whose operation has been completed from other domestic electric appliances.

Also, in the domestic electric appliance of the present invention, the wireless apparatus transmits information containing an operation completion time which corresponds to the appliance identification information.

In accordance with the above-described domestic electric appliance, since the information which contains the operation completion time instant corresponding to the appliance identification information is received, even when the user is present at such a room located apart from the domestic electric appliance under operation, the user can grasp the operation completion time instant.

As previously described, in accordance with the domestic electric appliance notification system, the portable terminal apparatus, the domestic electric appliance, and the operation completion notifying method, which are related to the present invention, the below-mentioned advantage can be achieved. That is, even under such an environment that the user cannot hear any sound, since the alarm is notified from the portable terminal apparatus, the user can grasp the operation completion of the domestic electric appliance. Also, the user is no longer required to continuously confirm the monitor fixed on the domestic electric appliance and the light emission.

### BRIEF DESCRIPTION OF THE DRAWINGS

FIG. 1 is a structural diagram of a portable terminal apparatus for notifying an alarm according to an embodiment mode of the present invention.

FIG. 2 is a structural diagram of a domestic electric appliance according to an embodiment mode of the present invention.

FIG. 3 is a diagram for schematically showing a data table employed in a pattern data storage apparatus according to the embodiment mode of the present invention.

FIG. 4 is a structural diagram for schematically indicating alarm setting information according to the embodiment mode of the present invention.

FIG. 5 is a structural diagram for schematically representing operation completion information according to the embodiment mode of the present invention.

FIG. 6 is a structural diagram for schematically representing operation completion information according to the embodiment mode of the present invention.

FIG. 7 is a structural diagram for schematically representing operation commencement information according to the embodiment mode of the present invention.

FIG. 8 is the structural diagram of the conventional domestic electric appliance.

### DESCRIPTION OF THE PREFERRED EMBODIMENTS

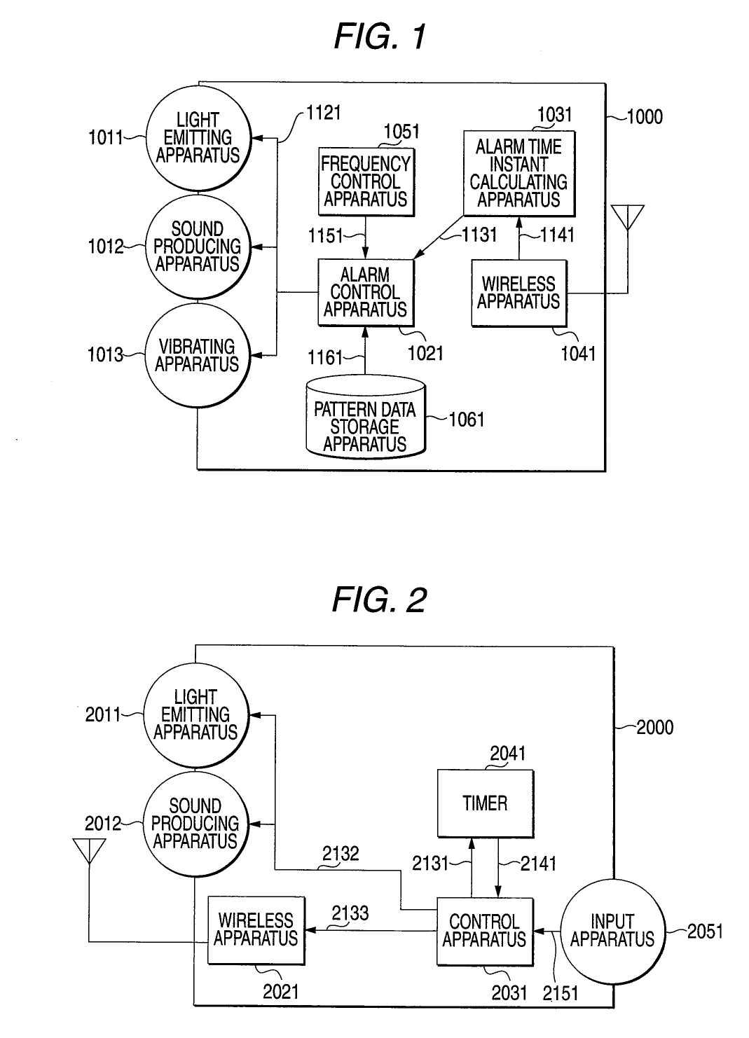

Next, embodiment modes of the present invention will now be described with reference to FIG. 1 to FIG. 7. FIG. 1 and FIG. 2 show a structure of a portable terminal apparatus and a structure of a domestic electric appliance, according to an embodiment mode of the present invention.

In FIG. 1, reference numeral 1000 indicates a portable terminal apparatus; reference numeral 1011 shows a light emitting apparatus for notifying an alarm; reference numeral 1012 indicates a sound producing apparatus for notifying an alarm; reference numeral 1013 denotes a vibrating apparatus for notifying an alarm; and reference numeral 1021 represents an alarm control apparatus. That is, the alarm control apparatus 1021 counts an alarm time instant; when the alarm time instant is expired, the alarm control apparatus 1021 notifies signals to the light emitting apparatus 1011, the sound producing apparatus 1012, and the vibrating apparatus 1013, which notify the alarms; otherwise, the alarm control apparatus 1021 notifies a control signal based upon operating pattern information of the alarm, or notifies a sound producing control signal based upon pattern information of a frequency characteristic so as to control the generations of the alarms. Also, reference numeral 1031 shows an alarm time instant calculating apparatus for calculating an alarm time instant which is set to the alarm control apparatus 1021 based upon operation completion information received via a wireless manner; reference numeral 1041 shows a wireless apparatus which is communicated with an external unit in a wireless manner; reference numeral 1051 denotes a frequency control apparatus for controlling a frequency characteristic of an alarm sound; reference numeral 1061 shows a storage apparatus for storing thereinto operation pattern information as to the light emission, the sound production, and the vibration; reference numeral 1121 denotes an appliance operating signal; reference numeral 1131 represents an alarm setting signal (alarm time instant and relevant information); reference numeral 1141 shows operation completion information; and reference numeral 1151 indicates frequency characteristic pattern information; and further, reference numeral 1161 represents operation pattern information.

In FIG. 2, reference numeral 2000 shows a domestic electric appliance; reference numeral 2011 indicates a light emitting apparatus for notifying an operation completion of the domestic electric appliance 2000; reference numeral 2012 represents a sound producing apparatus for notifying an operation completion of the domestic electric appliance 2000; and reference numeral 2021 indicates a wireless apparatus which is communicated with an external unit in a wireless manner; reference numeral 2031 shows a control apparatus calculates an operation completion time of the domestic electric appliance 2000, and further, notifies such signals for operating the light emitting apparatus 2011 and the sound producing apparatus 2012 when the operation of the domestic electric appliance 2000 is completed. Also, reference numeral 2041 shows a timer for counting an operation time, and for notifying expiration of the operation time to the control apparatus 2031; reference numeral 2051 shows an input apparatus with respect to the domestic electric appliance 2000; reference numeral 2133 represents operation start information, and operation completion information containing an operation completion time, relevant information, or a completion of an operation, which are transmitted via a wireless manner; reference numeral 2131 represents a timer setting signal; reference numeral 2132 indicates an appliance operating signal; reference numeral 2141 shows a timer counting expiration signal; and also, reference numeral 2151 denotes an input signal.

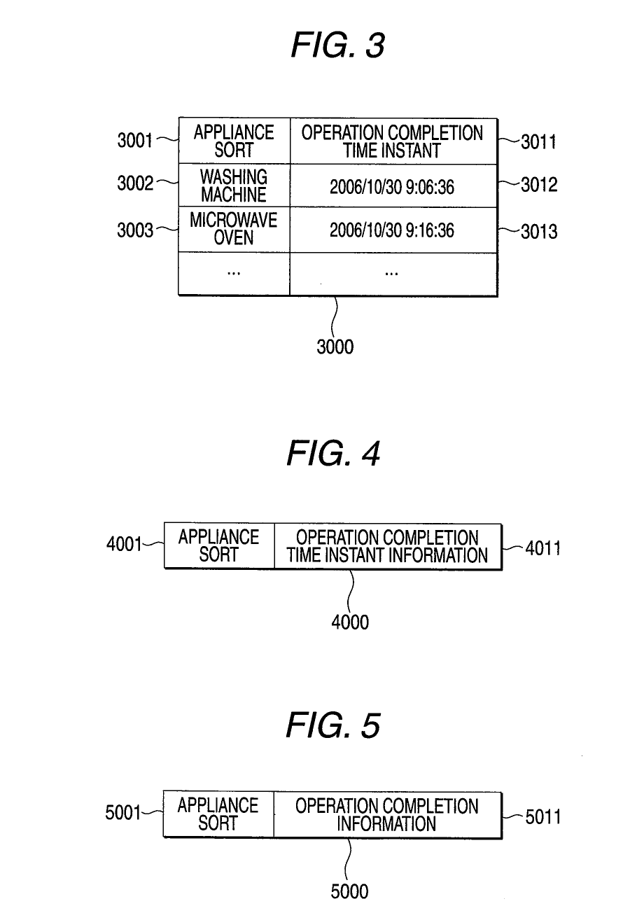

In FIG. 3, reference numeral 3000 represents a table for alarm time instant data that is stored in the alarm control apparatus 1021; reference numeral 3001 shows appliance sort information; and reference numeral 3011 indicates operation completion time instant information of the appliance sort information 3001.

In FIG. 4, reference numeral 4000 shows one format of alarm setting information that is notified by the alarm setting signal 1131; reference numeral 4001 indicates appliance sort information; and reference numeral 4011 denotes operation completion time instant information of an appliance which is indicated by the appliance sort information 4001.

In FIG. 5, reference numeral 5000 indicates one format of time information until operation completion which is notified by the operation completion information 2133 of the domestic electric appliance 2000, or the operation completion information 1141 of the portable terminal apparatus 1000; reference numeral 5001 represents appliance sort information; and reference numeral 5011 shows operation completion information of an appliance indicated by the appliance sort information 5001.

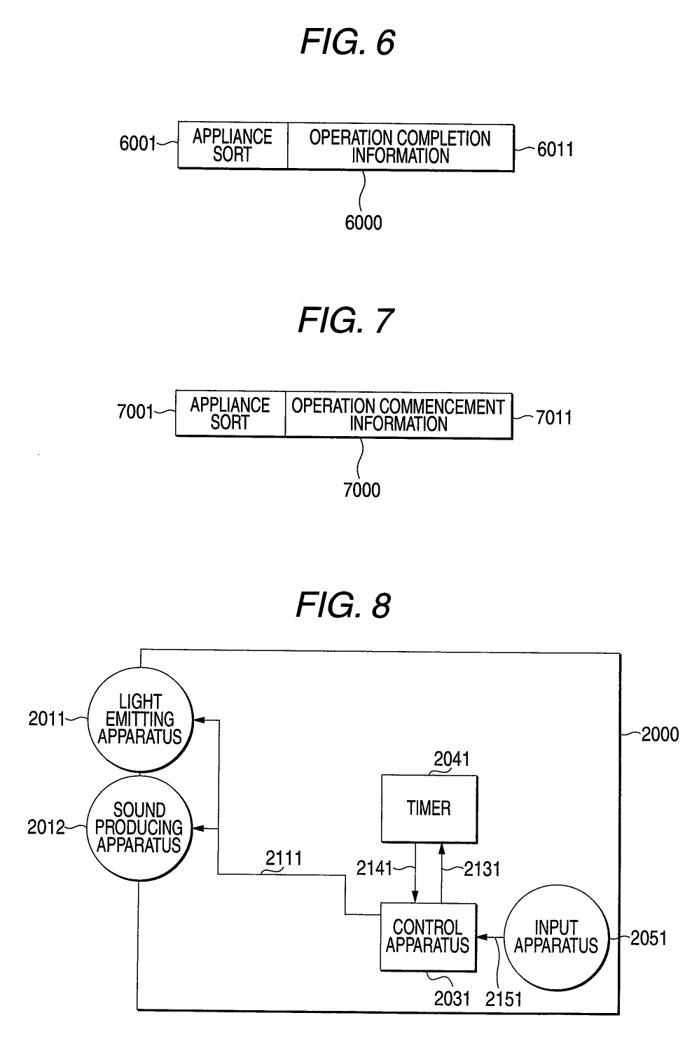

In FIG. 6, reference numeral 6000 represents one format as to either operation commencement information or operation completion information, which is notified by the operation completion information 2133 of the domestic electric appliance 2000, or the operation completion information 1141 of the portable terminal apparatus 1000.

Next, a concrete description is made of domestic electric appliances and portable terminal apparatuses, which can notify completion as to operations of the domestic electric appliances.

### Embodiment 1

When an Operation of the Domestic Electric Appliance 2000 shown in FIG. 2 is commenced by entering an input instruction with respect to the input apparatus 2051, an operation commencement 2151 is notified to the control apparatus 2031 based upon the input signal 2151. The control apparatus 2031 calculates an operation completion time 1141 so as to set the calculated operation completion time 1141 to the timer 2041, namely, the timer setting operation. The operation completion time 1141 calculated by the control apparatus 2031 is transmitted by the wireless apparatus 2021 to the portable terminal apparatus 1000 in the wireless manner.

In the portable terminal apparatus 1000 indicated in FIG. 1, when the operation completion time 1141 notified from the domestic electric appliance 2000 is received by the wireless apparatus 1041, the received operation completion time 1141 is notified to the time instant calculating apparatus 1031. The time instant calculating apparatus 1031 adds the operation completion time 1141 to the present time instant so as to form operation completion time instant information, and then, notifies the formed operation completion time instant information as alarm setting information 1131 to the alarm control apparatus 1021. The alarm control apparatus 1021 stores the notified alarm setting information 1131 in a column 3011 of the data table (refer to FIG. 3) of a column 3011 and sets the alarm setting information 1131 to the timer 2041 of the domestic electric appliance 2000. When one, or a plurality of time instant information stored in the column 3011 expires, the alarm control apparatus 1021 causes to operate the light emitting apparatus 1011, the sound producing apparatus 1012, and the vibrating apparatus 1013 by supplying the appliance operating signal 1121. As a result, the alarm control apparatus 1021 of the portable terminal apparatus 1000 can notify the operation end time of the domestic electric appliance 2000 to the user who is present at a place separated from the domestic electric appliance 2000.

### Embodiment 2

In a portable terminal apparatus 1000 according to an embodiment 2 of the present invention, the operation completion time information 5000 received from the domestic electric appliance 2000 is notified by the wireless apparatus 1041 to the alarm time instant calculating apparatus 1031 within the portable terminal apparatus described in the above-described embodiment 1. The alarm time instant calculating apparatus 1031 adds the operation completion time 1141 to the present time instant so as to form the completion time instant information 4000 (refer to FIG. 4), and then notifies the formed completion time instant information 4000 as the alarm setting signal 1131 to the alarm control apparatus 1021. The alarm control apparatus 1021 stores the appliance sort information 4001 in the column 3001 of the data table 3000, and also, stores the operation completion time instant 4011 in the column 3011 of the data table 3000.

When one, or a plurality of time instant information stored in the data table 3000 expires, the alarm control apparatus 1021 causes to operate the light emitting apparatus 1011, the sound producing apparatus 1012, and the vibrating apparatus 1013. As a result, the alarm control apparatus 1021 of the portable terminal apparatus 1000 can notify the operation end time of the domestic electric appliance 2000 to the user who is present at a place located apart from the domestic electric appliance 2000.

### Embodiment 3

In a portable terminal apparatus 1000 according to an embodiment 3 of the present invention, within the portable terminal apparatus described in the above-explained embodiment 2, the operation completion information 6000 received from the domestic electric appliance 2000 by the wireless apparatus 1041 is notified to the alarm time instant calculating apparatus 1031. In the case of the operation completion information 1141, the alarm time instant calculating apparatus 1031 adds such a value approximated to the present time instant with respect to the present time instant so as to form the completion time instant information 4000, and then, notifies the formed completion time instant information 4000 as the alarm setting signal 1131 to the alarm control apparatus 1021.

### Embodiment 4

In a portable terminal apparatus 1000 according to an embodiment 4 of the present invention, within the portable terminal apparatus described in the above-explained embodiment 2, as a method for notifying counting expiration of the timer 2041, the light emitting apparatus 1011, the sound producing apparatus 1012, and the vibrating apparatus 1013 are operated, so that the operation end time of the domestic electric appliance 2000 can be grasped.

### Embodiment 5

In a domestic electric appliance 2000 according to an embodiment 5 of the present invention, when an operation starting signal is notified from the input apparatus 2051 to the control apparatus 2031, operation commencement information 7011 is transmitted as the operation commencement information 7000 (refer to FIG. 7) by the control unit 2031 via the wireless apparatus 2021 with respect to the portable terminal 1000 in a wireless manner.

Also, when the timer counting expiration notification 2141 is notified to the control apparatus 2031, operation completion information 6011 is transmitted as the operation completion information 6000 by the control apparatus 2031 via the wireless apparatus 2021 with respect to the portable terminal apparatus 1000 in a wireless manner.

### Embodiment 6

In a domestic electric appliance 2000 according to an embodiment 6 of the present invention, within the domestic electric appliance described in the above-explained embodiment 5, when an operation starting signal is notified from the input apparatus 2051 to the control apparatus 2031, an operation completion time calculated by the control apparatus 2031 is transmitted as the operation completion information 5000 via the wireless apparatus 2021 with respect to the portable terminal apparatus 1000 in a wireless manner.

### Embodiment 7

In a domestic electric appliance 2000 according to an embodiment 7 of the present invention, within the domestic electric appliance described in the above-explained embodiment 5, the control apparatus 2031 adds the appliance sort information 5001, 6001, 7001 respectively as the operation completion information 5000, the operation completion information 6000, and the operation commencement information 7000, and then transmits the resultant information via the wireless apparatus 2021 with respect to the portable terminal apparatus 1000 in a wireless manner.

### Embodiment 8

In a portable terminal apparatus 1000 according to an embodiment 8 of the present invention, within the portable terminal apparatus described in the above-explained embodiment 4, when one, or the plurality of time instant information stored in the data table 3000 expires, the alarm control apparatus 1021 reads out the pattern data 1061 based upon the appliance sort information of the relevant column 3001, and controls the appliance operating signal 1121 based upon the read pattern data 1061 so as to control the operations as to the light emitting apparatus 1011, the sound producing apparatus 1012, and the vibrating apparatus 1013.

### Embodiment 9

In a portable terminal apparatus 1000 according to an embodiment 9 of the present invention, when a frequency setting signal is notified from an input apparatus (not shown) to the frequency control apparatus 1051, the frequency control apparatus 1051 notifies the frequency characteristic pattern information 1151 to the alarm control apparatus 1021. The alarm control apparatus 1021 controls the signal 1121 for controlling the sound producing apparatus 1012 in accordance with the characteristic of the frequency characteristic pattern information 1151 in order to control a frequency of a sound produced from the sound producing apparatus 1012.

As previously described, in accordance with the portable terminal apparatus 1000 and the domestic electric appliance 2000 related to the present embodiment mode, the below-mentioned effect can be achieved. That is, even under such an environment that the user cannot hear the sound produced from the domestic electric appliance 2000, since the portable terminal apparatus 1000 notifies the alarm, the user can grasp that the operation of the domestic electric appliance is completed, and also, the user is no longer required to continuously confirm the monitor fixed thereon and the light emission therefrom.

The present invention can be utilized as the domestic electric appliance capable of transmitting the operation completion information in the wireless manner, and also, as the portable terminal apparatus capable of notifying the alarm by the light, the sound, and the vibration, and also capable of setting the alarm time via the wireless function from the external unit.

What is claimed is:

1. An operation completion notifying method in which completion of an operation of a domestic electric appliance is notified by a portable terminal apparatus, comprising:
a step in which said domestic electric appliance transmits appliance sort information and operation completion information corresponding to said appliance sort information in a wireless manner;
a step in which said portable terminal apparatus receives said operation completion information transmitted from said domestic electric appliance and sets an alarm time based upon said received operation completion information; and
a step in which said portable terminal apparatus notifies an alarm based upon said set alarm time by emitting light, by performing a vibrating operation, or by producing a sound.

2. A domestic electric appliance notification system including a domestic electric appliance and a portable terminal apparatus capable of being communicated with said domestic electric appliance in a wireless manner, wherein:
said domestic electric appliance transmits appliance sort information and operation completion information corresponding to said appliance sort information in the wireless manner; and
said portable terminal apparatus receives said operation completion information transmitted from said domestic electric appliance and sets an alarm time based upon said received operation completion information so as to notify an alarm based upon said set alarm time by emitting light, by performing a vibrating operation, or by producing a sound.

3. A portable terminal apparatus capable of being communicated with a domestic electric appliance in a wireless manner, comprising:
a wireless apparatus for receiving operation completion information transmitted from said domestic electric appliance;
an alarm time instant calculating apparatus for calculating an alarm time instant based upon said received operation completion information; and
an alarm control apparatus for controlling a generation of an alarm based upon said calculated alarm time instant.

4. The portable terminal apparatus as claimed in claim 3, wherein:
said alarm time instant calculating apparatus is comprised of:
a timer for counting an operation time.

5. The portable terminal apparatus as claimed in claim 3, wherein:
said portable terminal apparatus is further comprised of:
a light emitting apparatus, a vibrating apparatus, or a sound producing apparatus, which produces an alarm by emitting light, by performing a vibrating operation, or by producing a sound in response to the control of said alarm control apparatus.

6. The portable terminal apparatus as claimed in claim 3, wherein:
said wireless apparatus receives appliance identification information for specifying said domestic electric appliance.

7. The portable terminal apparatus as claimed in claim 6, wherein:
said wireless apparatus receives information which contains an operation completion time instant corresponding to said received appliance identification information.

8. The portable terminal apparatus as claimed in claim 5, wherein:
said portable terminal apparatus is further comprised of:
a storage apparatus which stores thereinto a light emitting pattern of said light emitting apparatus, a sound producing pattern of said sound producing apparatus, and a vibration pattern of said vibrating apparatus; and wherein:
said alarm control apparatus controls switching operations as to said light emitting pattern, said sound producing pattern, and said vibration pattern based upon said appliance identification information.

9. The portable terminal apparatus as claimed in claim 8, wherein:
said storage apparatus is comprised of a data table which stores thereinto said appliance sort information and said operation completion time instant.

10. The portable terminal apparatus as claimed in claim 5, further comprising:
a frequency control apparatus for controlling a frequency characteristic of a sound produced from said sound producing apparatus.

11. A domestic electric appliance capable of being communicated with a portable terminal apparatus in a wireless manner, comprising:
a timer for counting an operation time so as to produce a timer counting expiration signal; and
a wireless apparatus for transmitting operation commencement information and operation completion information to said portable terminal apparatus in a wireless manner based upon said produced timer counting expiration signal.

12. The domestic electric appliance as claimed in claim 11, wherein:
said wireless apparatus transmits appliance identification information.

13. The domestic electric appliance as claimed in claim 12, wherein:
said wireless apparatus transmits information containing an operation completion time which corresponds to said appliance identification information.
